(19) United States
(12) Patent Application Publication
(10) Pub. No.: US 2016/0185071 A1
(43) Pub. Date: Jun. 30, 2016

(54) LAMINATE FOR HOOK/LOOP FASTENER AND METHOD OF MAKING SAME

(71) Applicant: MONDI Gronau GmbH, Gronau (DE)

(72) Inventors: Dieter HOMOELLE, Ochtrup (DE); Georg BALDAUF, Laer (DE)

(21) Appl. No.: 14/982,080

(22) Filed: Dec. 29, 2015

(30) Foreign Application Priority Data
Dec. 30, 2014 (DE) 102014119706.2

(51) Int. Cl. B32B 5/02; B32B 37/12; B32B 37/10; B32B 7/12

(52) U.S. Cl. CPC B32B 5/026; B32B 7/12; B32B 37/1207; B32B 37/10; B32B 2037/1215

(57) ABSTRACT

A laminate for hook-and-loop fasteners is made by supplying a knitted fabric, supplying a substrate film, applying a hot-melt adhesive to a face of the knitted fabric, and pressing the face of the knitted fabric carrying the hot-melt adhesive against a face of the of the substrate film so as to adhere the knitted fabric to substrate film.

### FIELD OF THE INVENTION

The present invention relates to a method of making a laminate for a hook-and-loop fastener. This invention also concerns the laminate thus made.

### BACKGROUND OF THE INVENTION

The laminate or a piece cut therefrom is provided as the female part of a hook-and-loop fastener, in particular for use in diapers or incontinence articles for adults.

In diapers, the laminate is fixed to the front waistband area of the diaper. The hook-and-loop fastener is completed with fastener strips that are laterally attached to the diaper and that have hook patches on their free ends. The individual hook-and-loop hooks can then engage in the laminate and connect with loops formed by a knitted fabric.

With a hook-and-loop fastener that the diaper is held in the waist area of the wearer of the diaper. Hook-and-loop fasteners can be repeatedly opened and closed without detriment to the continued functionality of the fastener. Unlike adhesive fasteners, hook-and-loop fasteners are not sensitive to contact with skin creams or powders.

Various requirements are imposed on a laminate for a hook-and-loop fastener for a disposable product such as a baby diaper or comparable incontinence article for adults. First, the laminate must establish sufficient possibilities for hooking of the hook-and-loop hooks and must also ensure a sufficient holding force.

Both the knitted fabric and its substrate film should further have the lowest possible grammage in spite of the sufficient holding force, in order to enable the most cost-effective production possible. Typically, an imprint is also provided in the area of the laminate, for which reason at least the outer knitted fabric should be translucent so that an underlying imprint is visible to a user.

Finally, the softest possible textile-like surface is also desired, as this is more comfortable for the user and imparts a particular impression of quality.

In particular for cost reasons with the desired low grammage, adhesion of the knitted fabric with the substrate film, is crucial for the functionality of the laminate. In practice, a one-component polyurethane (PUR) adhesive is typically applied to the substrate film, and the knitted fabric is adhered to the substrate film with the applied adhesive. It should be noted here that the adhesive can also be adhered to the individual loops so that the functionality of the laminate as a part of a hook-and-loop fastener is then impaired.

Against this background, various approaches are known from the prior art for producing a good hook-and-loop action with the method of the described type.

A laminate for hook-and-loop fasteners is thus known from U.S. Pat. No. 5,736,214 where the textile substrate is a knitted fabric of warp and weft filaments as well with the loops fixed in the knitted fabric. The textile substrate is adhered to the substrate film. The loops are of such a size that they rest on the mesh formed by the base fabric. The size of the loops ensures that they do not come into contact with the adhesive and retain their functionality. However, the previously discussed problem of ensuring both a good hook-and-loop action as well as a high connective strength between the substrate film and the textile substrate in the use of an open textile substrate is not yet fully solved. In particular, the connection between the substrate film and the textile substrate is still in need of improvement.

It is known from U.S. Pat. No. 7,527,898, US 2012/0088061, and US 2006/0080810 to apply the adhesive to the substrate film in a pattern so that the knitted fabric is then only locally adhered and adhesive-free regions remain. A deterioration of the hook-and-loop action caused by the adhesive is excluded in the adhesive-free regions. Simultaneously, the adhesive in the adhesive pattern can be laid on such that a secure adhesion is ensured locally. Where the adhesive is applied, adhesion of the loops provided for connection with the hook-and-loop hooks can also be tolerated to a certain extent.

In order to also avoid tearing of the knitted fabric from the substrate film, a peripheral adhesive frame is provided according to US 2012/0088061 at the edges of the individual laminates. Further, US 2012/0088061 also shows schematically the preferred structure of the knitted fabric that, as an array of knitted wales, comprises connecting filaments between the wales as well as loop-forming filaments. The loops may thereby be provided in that, during the knitting process, the respective filaments are processed with a lower tension or without tension. The knitted fabric is also designated as a “lock loop” knitted fabric.

By means of the described improvements and in particular the optimization of the adhesive pattern, inexpensive laminates can be provided that have sufficient hook-and-loop properties. Such products have also proven themselves accordingly in the market. The grammage of the knitted fabric may lie, for example, between 18 and 25 g/m², wherein the described “lock loop” knitted fabric is connected with a 14 thick film made from polyurethane by means of a one-component PUR adhesive. The one-component PUR adhesive cures through moisture, for which either atmospheric humidity is sufficient or an additional sprinkling with water may also occur. The substrate film, of polyurethane is typically provided with an imprint on its upper side opposite the knitted fabric.

### OBJECTS OF THE INVENTION

It is therefore an object of the present invention to provide an improved method of making a laminate for a hook-and-barb fastener used at the so-called “landing zone” of a diaper or hygiene product.

Another object is the provision of such an improved laminate for a hook-and-barb fastener that overcomes the above-given disadvantages, in particular that has improved mechanical properties and in particular a soft surface without an excessive increase in production costs.

### SUMMARY OF THE INVENTION

A laminate for hook-and-loop fasteners is made by supplying a knitted fabric, supplying a substrate film, applying a hot-melt adhesive to a face of the knitted fabric, and pressing the face of the knitted fabric carrying the hot-melt adhesive against a face of the of the substrate film so as to adhere the knitted fabric to substrate film.

According to the invention, a hot-melt adhesive is used that is not applied to the substrate film, but rather to the knitted fabric. The viscosity of the hot-melt adhesive can be accurately adjusted by suitable temperature control, and is applied directly to the knitted fabric. Unlike an application of the adhesive to the substrate film, the hot-melt adhesive is present only on the filaments of the knitted fabric, giving rise to a more efficient adhesion, whereas in application of the adhesive to the substrate film, sections and interstices that are juxtaposed with voids of the knitted fabric are also always provided with adhesive. A further advantage is that exactly that side of the knitted fabric that is to be adhered to the substrate film is provided with hot-melt adhesive, without also binding the free loops on the opposite side. In particular, the viscosity of the hot-melt adhesive can be adjusted such that it is not distributed in an uncontrolled manner in the knitted fabric, to which end the hot-melt adhesive is preferably applied in a slightly viscous state.

The hot-melt adhesive is preferably applied to the face of the knitted fabric with a grammage between 2 g/m² and 5 g/m². As described above, this has the advantage that the hot-melt adhesive can then be adhered to individual filaments of the knitted fabric, and is thus present there in sufficient quantity. Filaments present on the opposite side or against interstices carry no hot-melt adhesive, thus resulting in a particularly efficient usage of the adhesive.

The hot-melt adhesive can be applied, for example, with a roller that is provided with adhesive over its entire surface, so that the knitted fabric can accept adhesive over the entire surface of the roller. In addition, the hot-melt adhesive can also be applied in a pattern by the roller in order to achieve a further optimization as in US 2012/0088061. However, as in the present invention, unlike in the prior art, the hot-melt adhesive is first put on the face of the knitted fabric and thus remains free from of its interstices as well as the opposite side of the knitted fabric, the hot-melt adhesive may also simply be provided on the entire surface.

Furthermore, it is also possible to apply the hot-melt adhesive to the knitted fabric from above with an extrusion die, in a pattern or across the entire surface. Then, too, the advantage arises that, with an appropriate viscosity of the hot-melt adhesive, the hot-melt adhesive does not penetrate deeply into the knitted fabric, and cannot bond on the opposite side to the free loops formed there.

As described above, the viscosity of the hot-melt adhesive is also of importance in its processing. At the processing temperature, the dynamic viscosity η thus preferably lies between 2 Pa·s and 6 Pa·s. In the described range, the hot-melt adhesive can be well-processed, adhere to the knitted fabric and adhere to the substrate film, without the hot-melt adhesive penetrating into the knitted fabric.

In the context of the invention, a hot-melt adhesive can be used, for example, which is based on a styrene-isoprene-styrene copolymer (SIS). The processing temperature may lie, for example, between 150° C. and 170 C. Particularly preferably, the hot-melt adhesive has a viscosity during processing of between 3 Pa·s and 5 Pa·s, and then the processing temperature may preferably lie in particular between 155° C. and 165 C.

As a further measure, during application of the hot-melt adhesive via a roller, the knitted fabric is guided on the upper side of the roller, so that the hot-melt adhesive is then located on the lower face of the knitted fabric, and due to gravity, the hot-melt adhesive cannot penetrate more deeply into the knitted fabric and undesired adhesion of the free loops can be prevented.

According to a preferred embodiment of the invention, a loop-forming knitted velour is used as the knitted fabric. This is a knitted fabric produced by two guide bars and having freely projecting loops.

After the stitch formation, i.e. the active process in the narrow sense, and before thermal fixation, the knitted fabric is preferably brushed to form and orient the loops before the hot-melt adhesive is applied. In practice, the thermal fixation is also referred to as finishing, and is typical in textile materials made of plastic. In thermal fixation, the material is heated to such a degree that, although the individual filaments are not melted, internal stresses are nevertheless reduced by viscous flow of the polymer chains.

Thus, the loops are first formed by brushing, and the material may also contract to a certain extent. The thus obtained structure is then permanently fixed by finishing.

Particularly preferably, the knitted velour is knitted with a first guide bar guided in a pattern of 1-0/1-2 and a second guide bar guided in a pattern selected from the group of 1-0/2-3, 1-0/3-4 and 1-0/4-5. Such a knitted velour, also referred to as a “loop-raised fabric,” is known, for example, from the specialist publication “Warp Knitting Technology, D. F. Paling, 2nd Edition 1965,” pages 100 and 101.

The knitted velour is distinguished by high softness, high volume and improved mechanical properties. It is understood that this advantage is at least partially due to the fact that the individual loops formed from the knitted velour extend across a plurality of wales due to the laying pattern.

The grammage of the knitted fabric lies preferably between 25 g/m² and 40 g/m².

According to a preferred embodiment of the invention, the substrate film is printed on the face being adhered to the glue-coated knitted fabric. The imprint on the substrate film, thus occurs on the face to which the knitted fabric will also subsequently be glued. This gives the advantage that the imprint is thus visible only through the knitted fabric and not through the knitted fabric and the substrate film, so that the imprint is clearer and has a higher quality.

Polyamide and polyester in particular are suitable as materials for the knitted fabric. According to a particularly preferred embodiment of the invention, the knitted fabric is formed from a first group of polyamide filaments and a second group of polyester made of polyester, in particular polyethylene terephthalate (PET). Each of the two groups is then assigned to one of the two guide bars.

The fineness of the filaments is preferably between 15 and 45 dtex, more preferably between 20 and 35 dtex, and a multi-filament yarn may also be used.

A subject of the invention is also a laminate for hook-and-loop fasteners with a substrate film, and a loop-forming knitted fabric adhered to the substrate film, with a grammage between 20 and 60 g/m². According to the invention, the knitted fabric is a knitted velour that is adhered to the substrate film, by a hot-melt adhesive coated first on the knitted fabric. The application of the hot-melt adhesive to the knitted fabric is also immediately recognizable in the finished laminate, as no adhesive is present in the interstices of the knitted fabric and the adhesive adheres only to filaments of the knitted fabric.

As previously described, the laminate preferably has an imprint on the face turned toward the substrate film, adhered to the knitted fabric, which imprint is then highly visible through the knitted fabric.

The substrate film, may have a thickness between 8 μm and 50 μm, preferably between 10 μm and 20 μm. Substrate films made from polyolefin, for example polyethylene (PE), are particularly suitable.

### BRIEF DESCRIPTION OF THE DRAWING

The above and other objects, features, and advantages will become more readily apparent from the following description, reference being made to the accompanying drawing in which:

FIG. 1 is a large-scale section through the layers of a laminate according to the invention;

FIG. 2 is a sectional view of a detail of an embodiment of the invention;

FIG. 3 is a small-scale top view of a production process for making the inventive laminate;

FIGS. 4A and 4B are side views of variants on the production process; and

FIG. 5 is a large-scale view of the velour knit prior to brushing and thermofixing.

### SPECIFIC DESCRIPTION OF THE INVENTION

As seen in FIG. a laminate according to the invention is formed by a knitted fabric 1 and a substrate film 2 that are adhered by a layer 3 of a SIS-based adhesive. The substrate film 2 has an imprint 4 on the side connected to the knitted fabric 1.

The laminate shown forms the female part of a hook-and-loop fastener, and the substrate film 2 can be applied with the side opposite the knitted fabric 1 to the front waist area of a diaper. On the outer side formed by the knitted fabric 1, the imprint 4 is visible through the knitted fabric 1. In the illustrated embodiment, the substrate film 2 is formed from polyethylene and has a thickness of 14 μm.

As will be explained in detail below, the knitted fabric 1 is a knitted velour with a grammage of 25 g/m². The hot-melt adhesive 3 is provided on the imprint 4 with a grammage between 3 to 5 g/m².

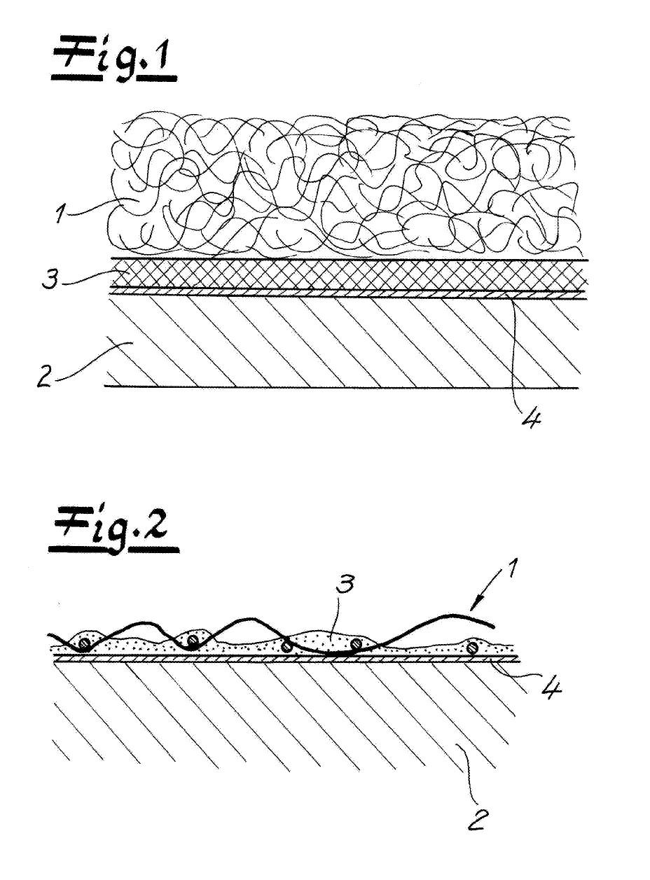

According to the invention, the hot-melt adhesive 3 is applied to the knitted fabric 1 in the production described subsequently in detail. Accordingly, the hot-melt adhesive 3 first bonds to the individual filaments of the knitted fabric 1, so that as to ultimately form a connection of the individual filaments with the substrate film 2 as shown in FIG. 2. Interstices in the knitted fabric 1 as well as filaments of the knitted fabric 1 projecting from the plane are not adhered.

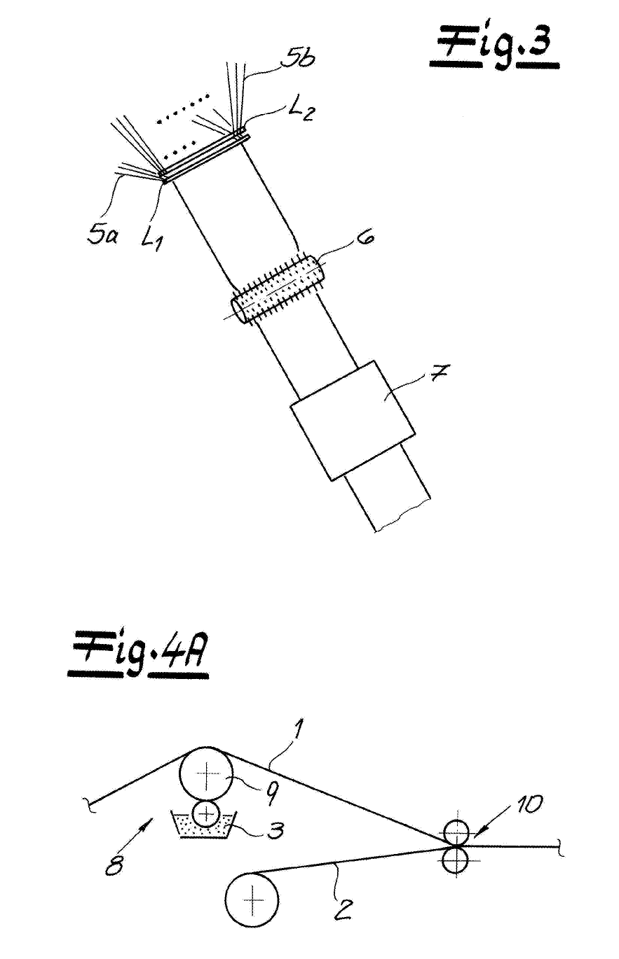

FIG. 3 shows the method steps for preparation of the knitted fabric.

First, the knitted fabric 1 is formed as a knitted velour with a first guide bar L₁ and a second guide bar L₂. Here, the first guide bar L₁ is guided in a pattern of 1-0/1-2, while the second guide bar L₂ is guided in a pattern selected from the group 1-0/2-3, 1-0/3-4 and 1-0/4-5.

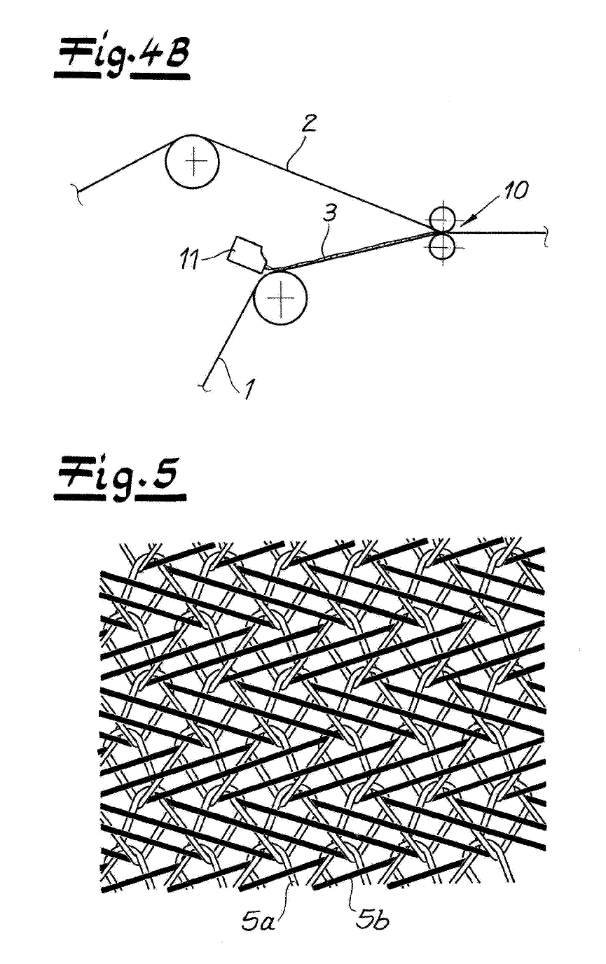

This produces the knitted velour shown in FIG. 5, with a first group of filaments 5a and a second group of filaments 5b.

Subsequently, the thus-formed knitted velour is brushed, to which end the brush roller 6 of FIG. 3 is used. During brushing, upstanding loops are formed from the filaments 5b of the second group.

Then the knitted velour is thermofixed in a fixing apparatus 7.

The thus prepared knitted fabric 1 can then be coated on its lower face with the hot-melt adhesive layer 3 according to FIG. 4A. The hot-melt adhesive 3 may be applied, for example, by an applicator 8 that has a transfer roller 9. The knitted fabric 1 then removes the hot-melt adhesive 3 from the transfer roller 9, so that only the underlying filaments of the knitted fabric 1 are provided with the hot-melt adhesive 3. The hot-melt adhesive 3 is applied with an average grammage between 2 and 5 g/m², and in particular as an SIS-based hot-melt adhesive 3 at a processing temperature between 150° C. and 170° C., in particular between 155° C. and 165° C. The viscosity is preferably between 2 Pa·s and 6·Pa·s, particularly preferably between 3 Pa·s and 5 Pa·s. This ensures that the hot-melt adhesive 3 adheres well to the knitted fabric 1 and thus also enables a connection with the substrate film 2, but is not excessively distributed into the knitted fabric 1,t that is only lies on a surface thereof.

FIG. 4B shows an alternative variant for the formation of the laminate, wherein the substrate film 2 is supplied to the roller nip 10 from above, and the knitted fabric 1 is supplied from below. The hot-melt adhesive 3 is then applied across the entire surface of the knitted fabric 1 from above via an extrusion die 11, wherein a coating is formed on the knitted fabric 1 that connects inwardly with the filaments of the knitted fabric and also gathers on the individual filaments, whereby, however, the viscosity of the hot-melt adhesive 3 is adjusted such that the hot-melt adhesive 3 does not penetrate too deeply into the knitted fabric, so that the underlying loops of the representation according to FIG. 4 are not also bound. Expediently, a small clearance is provided between the extrusion die 11 and the knitted fabric 1, so that a direct contact between the extrusion die 11 and the knitted fabric 1 is avoided. The clearance from the extrusion die 11 to the roller nip 10 should be adjusted such that the hot-melt adhesive 3 does not cool too strongly.

According to FIG. 3, the knitted fabric 1 that has been provided with the hot-melt adhesive 3, and the substrate film 2 are connected with one another in a roller nip 10. It is not shown that the substrate film 2 can be provided with an imprint 4 in a conventional manner before the connection with the knitted fabric 1.

In tests, a laminate according to the invention was compared with Samples I, II, and III, and the holding forces (peel) were determined with two different hook materials, 3M Global Hook and Aplix 980. The laminate was applied here to an adhesive strip, in order to achieve a sufficiently high mechanical strength.

The determined peel strength characterizes the adhesion and peeling of the hook material on the laminate, after the hook material is pressed onto the laminate with a specific weight and then peeled off. The test was performed in a tensile test using a Zwick machine, whereby the two ends of the sample (hook material on one side and the laminate on the other) were clamped into the clamping jaws of the Zwick machine. Both the hook material and the laminate were provided with a sample width of 25.4 mm. The test was performed at an ambient temperature of 23° C.±2° C. and a humidity of 50%±2%, wherein these parameters were held constant for at least 2 hours. To achieve uniform testing conditions, the hook strip and the laminate were held between thumb and forefinger for 3 seconds, compressed, before a hanging weight of 500 g was applied to the sample for 5 seconds. After removal of the weight, the force per inch necessary for peeling off (peel strength) was determined.

The results of the investigation are shown in Table 1,

TABLE 1

| | Peel value EM Global | Peel value Aplix | |
|---|---|---|---|
| | Hook in N/in | 980 in N/in | Soft Touch |
| Invention | 3.9 | 3.4 | Very good |
| Example I | 2.3 | 2.2 | Sufficient |
| Example II | 2.0 | 1.6 | Satisfactory |
| Example III | 2.6 | 2.5 | Satisfactory |

Clear qualitative differences can be seen independent of the exact execution of the tests. In the laminate according to the invention, a knitted fabric 1 in the form of a knitted velour with a grammage of 35 g/m² was coated with hot-melt adhesive at a grammage of the hot-melt adhesive of 3.5 g/m² and laminated with the substrate film 2. In Example I, a standard laminate known from the market was used, with a knitted fabric according to US 2012/0088061 with a grammage of 18 g/m² laminated to the substrate film 2 with a one-component PUR adhesive. The application of the adhesive took place in an adhesive pattern.

In Example II, a knitted velour according to the present invention was laminated with the substrate film 2 with a one-component PUR adhesive in an adhesive pattern at a coating weight of 2 g/m². According to Example III, however, a full-surface adhesion of an identically formed knitted fabric with a one-component PUR adhesive and the coating weight of 2 g/m² took place.

It is evident from Table 1 that the laminate according to the invention is distinguished by particularly good mechanical properties. Moreover, there also results a particularly soft and pleasant feel for the user, which is indicated in the table as “soft touch.”

We claim:

1. A method of making a laminate for hook-and-loop fasteners comprising the steps of:
supplying a knitted fabric;
supplying a substrate film;
applying a hot-melt adhesive to a face of the knitted fabric; and
pressing the face of the knitted fabric carrying the hot-melt adhesive against a face of the of the substrate film so as to adhere the knitted fabric to substrate film.

2. The method defined in claim 1, wherein the hot-melt adhesive is applied to the face of the knitted fabric with a grammage between 2 and 5 g/m².

3. The method defined in claim 1, wherein the hot-melt adhesive is applied with a transfer roller.

4. The method defined in claim 1, wherein the hot-melt adhesive is applied to the face of the knitted fabric at a viscosity between 2 Pa·s and 6 Pa·s.

5. The method defined in claim 1, wherein the knitted fabric is a loop-forming knitted velour.

6. The method defined in claim 5, further comprising the steps of:
knitting the velour with a first guide bar guided in a pattern of 1-0/1-2 and with a the second guide bar guided in a pattern selected from the group of 1-0/2-3, 1-0/3-4 and 1-0/4-5.

7. The method defined in claim 5, wherein, after stitch formation and before thermal fixation, the knitted fabric is brushed form and orient loops before the hot-melt adhesive is applied.

8. The method defined in claim 1, wherein the knitted fabric is supplied at a grammage between 25 g/m² and 60 g/m².

9. The method defined in claim 1, further comprising the step of:
printing on the face of the substrate film prior to adhering to the knitted fabric.

10. The method defined in claim 1, further comprising the step of:
forming the knitted fabric from polyamide filaments and polyester filaments.

11. A laminate for a hook-and-loop fastener and comprising:
a substrate film;
a loop-forming knitted velour adhered to the substrate film and having a grammage between 20 and 60 g/m²; and
a layer of hot-melt adhesive adhered to the knitted fabric and adhering the knitted fabric to the substrate film.

12. The laminate defined in claim 11, further comprising:
an imprint on a face of the substrate adhered by the adhesive to the knitted fabric.
